(19) United States
(12) Patent Application Publication
(10) Pub. No.: US 2024/0063690 A1
(43) Pub. Date: Feb. 22, 2024

(54) ADVANCED KINETIC ENERGY RECOVERY SYSTEM (AKERS) FOR ELECTRIC AIRCRAFT

(71) Applicant: Michael Curtis Grayson, Bolivar, TN (US)

(72) Inventor: Michael Curtis Grayson, Bolivar, TN (US)

(21) Appl. No.: 18/205,899

(22) Filed: Jun. 5, 2023

Related U.S. Application Data
(63) Continuation-in-part of application No. 17/868,939, filed on Jul. 20, 2022.
Application No. 17/868,939 is a continuation of application No. 17/590,779, filed on Feb. 1, 2022.
Application No. 17/590,779 is a continuation of application No. 16/801,505, filed on Feb. 26, 2020, now abandoned.
(60) Provisional application No. 63/259,492, filed on Jul. 20, 2021.

(51) Int. Cl. H02K 7/18; H02J 7/00; B60L 53/50; B60L 50/90; H02K 11/00; B60L 53/60

(52) U.S. Cl. CPC H02K 7/1846; H02J 7/007; B60L 53/50; B60L 50/90; H02K 11/0094; B60L 53/60

(57) ABSTRACT

An electric aircraft powered and recharged by multiple redundant independent charging systems to ensure extended operation of the aircraft during normal operations. All systems are configured as electrical machine generators responsive to kinetic energy for generating electricity and are operatively combined to provide a constant high volume of charge sufficient to sustain operation of the aircraft for great distances and speeds. This means that this long-range aircraft can fly nonstop for almost 8 hours. The multiple redundant independent charging systems includes three advanced kinetic energy recovery systems including: a Paddlewheel Air Brake system, an Air Turbine with Exhaust Cone Generator system, and a Blade Rotors generation system and a first fly-by-wire aircraft to aircraft midair recharging system. The power from each machine system is routed to a smart charge combiner, a smart high-voltage ultracapacitor storage system, then the aircraft or battery bank under control of a smart charge controller.

### PRIORITY

This application is a continuation-in-part of co-pending U.S. patent application Ser. No. 17/868,939 (41164Z) filed with the U.S. Patent and Trademark Office on Jul. 20, 2022 which claims the benefit of U.S. Provisional Patent Application No. 63/259,492 filed with the U.S. Patent and Trademark Office on Jul. 20, 2021, the entire contents of which is incorporated herein by reference. This application also claims benefit of U.S. patent application Ser. No. 17/590,779 (40784Z) filed with the U.S. Patent and Trademark Office on Feb. 1, 2022 which is a continuation of and claims the benefit of U.S. patent application Ser. No. 16/801,505 filed with the U.S. Patent and Trademark Office on Feb. 26, 2020, the entire contents of both of which is incorporated herein by reference.

### BACKGROUND

The present invention relates generally to aircraft electronics generally, and particularly systems and methods for providing kinetic energy for powering and recharging an electric aircraft and, including provision of range extending systems and methods for dramatically increasing an aircraft's operating range and greatly reducing or eliminating the need for recharging.

While much greater in efficiency, the resultant power of electric aircraft is at least 30 times less than that of fuel-engine aircraft. One kilogram of Lithium-Ion battery pack stores approximately 200 watt-hours of energy. At 90% average efficiency, the power to run the shaft is 180 watts for one hour. This results in about 0.25 horsepower to run the shaft for one hour using one kilogram of battery. Based on this calculation, it is evident that the resultant power of a gas turbine engine is at least 30 times greater than that achieved from an electric motor. In terms of volume, one liter of jet fuel stores 20 times more energy than one liter of Lithium-Ion battery. Conventional battery systems are suboptimal for use in aviation as seen by their average range of 300 miles or up to 20 minutes of flight, including takeoff and landing. With the aircraft's top speed of 210 mph (337 kph), it can perform only up to five minutes of full-throttle cruise flight. An electric aviation motor suffers from low horsepower and low power-to-weight ratio from usually two battery packs. With 37.2 kWh of battery power, the maximum operational time for the aircraft is 30 minutes. Currently these aircraft can only be used for short-range lightweight missions. It will be years until thousands of kilograms of battery can be added to increase the operational range of electric aircraft.

Although pure electric aircraft have the advantage of energy-savings, environmental protection, and zero discharge, the continual mileage range is currently very limited. In order to achieve mass application and acceptance the electric aircraft range must meet or exceed that of conventional fossil fuel powered aircraft. Currently 300 miles is the average range for an electric aircraft. This range makes electric air travel very limited and impractical for most applications. It would be very easy to give the aircraft a higher range, just put in a bigger battery. However, for electric aircraft, the solution is not as simple. The average range of an aircraft is currently about 1500 miles. Adding more battery as the solution for perceived range needs only adds more cost to the profitability-challenged electrified aircraft but more importantly makes a weight sensitive aircraft only a dream of the future. More Mass on the aircraft is unacceptable. Batteries are very heavy. In order to meet very stringent fuel economy & CO2 targets globally (primarily China, Europe, US & CA), all aircraft will have to be lighter and more mass efficient. OEM's will pay more in premium materials for weight savings. Adding 4 lbs. of battery mass is roughly equal to 1 mile of range.

Longer Charging Times to Top-off. Charging Infrastructure for Long Distance Trips under currently under Development, however no solution is close at hand. Charging an electric aircraft would be a major barrier. The larger the batteries become, the more faster charging solutions are required, however, continuous high-power charging can increase battery degradation.

More Structural Requirements for Crashworthiness. Must Protect the Bigger Batteries. We are often reminded that both gas tanks and batteries contain so much energy and they need to be carefully protected from thermal events that can occur during crashes. Larger batteries are greater engineering challenges requiring more substantive structures/systems. More Robust Support Systems Required Mass Begets Mass As the battery grows and the mass of the aircraft increases, other components from landing gear, suspension, thermal management, etc. must be designed and reinforced to handle these challenges; the result is even more mass and cost added to the aircraft.

Without solutions to all these problems the electric aircraft just cannot advance.

### SUMMARY

In one aspect, there is provided Grayson Range Extender (GRE) electric power generation systems and methods that address each and every one of the aforementioned problems in a practical, reliable, and cost-effective way for increasing and extending the range of electric aircraft vehicles.

GRE range extending generator systems have the advantage of high efficiency, high power density, and have wider application prospects. In existing technology, the GRE will prove to be a compatible device that can quickly integrate with all current electrical aircraft platforms.

Embodiments provide an approach to charging an electric aircraft that includes improved operating safety. The system is configured to provide kinetic energy for recharging and increase range. The system includes at least one or more electrical machine generators for providing kinetic energy, and additionally a midair recharging system that may be operated as either a receiver or source of electricity, in order to gain exponential range extension, provide more power for greater engine power, create a platform that will have immediate and long-term environmental benefits while simultaneously reducing charging times, improving overall efficiency.

The range extending generator systems propose the only practical redundant system for long range aircraft.

In aspect, there is provided one or more aircraft recharging systems that greatly extends the range of an aircraft vehicle, the recharging systems configurable as a series of high-speed high efficiency heat resistant fluid turbine generator type range extender and rechargers for electric aircraft, dramatically increasing the flying range and greatly reducing or eliminating the need for recharging. These device(s) are referred to as a Grayson Range Extender (GRE). These systems provide a plurality of charging systems to add redundancy of charging. Redundancies are provided in the aircraft systems in order to provide good safety. Because these systems can be attached at numerous places on the subject aircraft this design is modular and scalable, the power produced is customizable to the desired recharge time and range. The range extender (AKERS) is characterized in that it comprises four (4) redundant recharging systems: a Paddlewheel Air Brake (PAB) system, a Grayson Air Turbine (GAT) with exhaust cone generator, a Grayson Blade Rotors (GBR), and an Air to Air (A2A) recharging system/protocol.

According to an embodiment, there is provided, a power generation system for an electric or hybrid aircraft vehicle. The power generation system comprises: a high-speed, high efficiency, heat resistant, fluid turbine generator type range extender, motor and recharger apparatus having: one or more computer controlled Concentrating Ducting Inlets (CDI) mounted to the outside surface of the electric aircraft for receiving air from outside the aircraft, the CDI having a diverging nozzle to accelerate received input air; a hardware processor configured to control the flow of received air through each CDI; and one or more of: a first electrical machine generator system connected to an output of the CDI for receiving the controlled air flow from an output thereof and for generating electricity responsive to the controlled air flow; a second electrical machine generator system for connection to an output of the first electrical machine generator system, the second electrical machine generator for generating electricity responsive to the controlled air flow; a third electrical machine generator system, the third electrical machine generator system comprising a dual blade rotor (BR) electrical generation system for generating electricity responsive to the motion of propeller blades; and an energy storage and delivery system adapted to receive generated electricity from each of the first-, second- third-electrical machine generator systems and store the generated electricity for use by the aircraft.

The present invention provides a modular scalable frictionless advanced kinetic energy recharging system for electric aircraft that can be located at numerous places on the subject aircraft vehicle the power produced is scalable to the desired recharge time and range.

### BRIEF DESCRIPTION OF THE SEVERAL VIEWS OF THE DRAWINGS

The drawings included in the present application are incorporated into, and form part of, the specification. They illustrate embodiments of the present disclosure and, along with the description, serve to explain the principles of the disclosure. The drawings are only illustrative of some embodiments and do not limit the disclosure.

FIGS. 1A-1D depicts example electric aircraft showing exemplary placement of a smart Concentrator Duct Inlet (CDI) and Paddlewheel Air Brake (System 1) energy generation system for an electric aircraft.

FIG. 1C depicts a further sample placement of the Paddlewheel Air Brake on a further electric aircraft vehicle according to an embodiment;

FIGS. 2A and 2B depict an example CDI/PAW electric generation system that can be situated at a variety of locations at the electric aircraft;

FIG. 3A shows an exploded view of an alternate embodiment of the Paddlewheel Air Brake Generator that consists of: an outer magnet connected to an inner surface of a rotatable paddlewheel housing (paddlewheel cylinder casing) which casing encompasses a first paddlewheel generator;

FIG. 3B depicts inner magnets attached to the shaft and outer magnets attached to the device that spins according to an embodiment;

FIG. 4A depicts an operation of a generator connected to the Paddlewheel Air Brake system according to an embodiment;

FIG. 4B depicts an operation of a second high-speed generator system connected to the Paddlewheel Air Brake generator system (first generator system);

FIG. 4C depicts the engagement of the second (high-speed) generator with the first PAB generator system via engaging shaft;

FIG. 4D depicts an alternative view depicting an engagement of the gear multiplier of a second high-speed generator system including rotor stator design to the first PAB generator system;

FIG. 5 depicts an aircraft equipped with multiple Paddlewheel Air Brake (PAB) systems according to an embodiment;

FIG. 6 shows a configuration of smart self cooling flash ultracapacitor storage device for use in any of the system charge generation embodiments for an aircraft;

FIG. 7 depicts a portion of an airplane vehicle having further electrical recharging system referred to as the Grayson Air Turbine (GAT) with Exhaust Cone Generator (ECG) device shown situated on the aircraft fuselage surface according to an embodiment;

FIG. 8 depicts two perspective views of the Grayson Air Turbine (GAT) system used to convert kinetic energy into energy for a rotating shaft according to an embodiment;

FIG. 9 depicts two exposed inner views of the Grayson Air Turbine showing the discs in spaced apart configuration within the housing to reduce drag responsive to received input air flow from the CDI;

FIG. 10 depicts a further exposed inner view of the Grayson Air Turbine showing the discs rotatable about axle in spaced apart configuration as programmed using shim spacer within the housing in an embodiment;

FIG. 11 shows an internal view of an encasing for a fluid cooled Flat Pancake Generator system in an embodiment;

FIG. 12 depicts components of a further range extending Exhaust Cone Generator (ECG) system coupled to receive exhaust air from the Grayson Air Turbine (GAT) according to an embodiment;

FIG. 13 depict rotor/stator components of the Exhaust Cone Generator (ECG) system according to an embodiment;

FIG. 14 shows an electric aircraft including a blade-based rotor stator energy generation system situated at the nose of the plane in a non-limiting embodiment;

FIG. 15 depicts a Grayson Blade Rotor Generator assembly having a stator be positioned in front and/or behind a blade rotor assembly in an embodiment;

FIG. 16 depicts a Grayson Blade Rotor Generator assembly of an electric aircraft vehicle according to an embodiment;

FIG. 17 depicts an embodiment of a Grayson Blade Rotor Generator assembly having contra rotating propellers for an electric aircraft vehicle according to an embodiment;

FIG. 18 depicts a portion of a Grayson Blade Rotor Generator assembly in which a stator can be positioned in front and behind the rotor in a ducting assembly for aircraft and watercraft;

FIG. 19 depicts an exemplary Air-to-Air (A2A) electric aircraft recharging system including an example recharging deployment for A2A system and a recharging receptacle for the electric aircraft;

FIG. 20 depicts a cross-sectional view of the recharging receptacle for an electric aircraft;

FIG. 21 depicts a further embodiment of an A2A electric aircraft recharging system including a first sample boom deployment and an alternative sample boom deployment;

FIG. 22 depicts the Long-Range Electric Aircraft Configuration depicting several Paddlewheel Air Brake systems at various locations on the wing edge of the electric aircraft; and

FIG. 23 depicts alternated locations on the aircraft A2A for a first charge controller receptacle connected to the battery at the rear of the plane, or alternatively placement of a charge controller receptacle, at or on a surface of a rear wing in an embodiment.

### DETAILED DESCRIPTION

Embodiments of the invention provide systems and methods for electrical energy generation for extending the range of an electric aircraft, particularly, redundant recharging systems for extending the range of an electric aircraft or any aircraft vehicle powered in whole or in part by electricity, or similar hybrid fuel, or similar Airships, or similar unmanned aircraft, or similar Vertical flight vehicles, or similar Experimental demonstrators, or similar Solar aircraft, or similar General aviation vehicles, or similar Airliner projects, or similar Electric vertical takeoff and landing planes, or eVTOLs, use electric power to hover, take off, and land vertically or similar Electric helicopters, or similar Urban Air Mobility (UAM) such as drones, for transportation within urban areas and electric driven aircraft vehicle.

In aspect, one or more aircraft recharging electrical energy generation systems are provided that greatly extend the range of an aircraft vehicle, the recharging systems configurable as a series of high-speed high efficiency heat resistant fluid turbine generator type range extender and rechargers for electric aircraft, dramatically increasing the flying range and greatly reducing or eliminating the need for recharging. These device(s) are referred to as a Grayson Range Extender (AKERS). These systems provide a plurality of charging systems to add redundancy of charging. Redundancies are provided in the aircraft systems in order to provide good safety. Because these systems can be attached at numerous places on the subject aircraft this design is modular and scalable, the power produced is customizable to the desired recharge time and range.

The advanced kinetic energy recovery system (AKERS) is characterized in that it comprises four (4) redundant recharging systems: a Paddlewheel Air Brake (PAB) system, a Grayson Air Turbine (GAT) with exhaust cone generator, a Grayson Blade Rotors (GBR), and an Air to Air (A2A) recharging system/protocol. In normal operating states, a control system is configured to control and monitor a fluid cooled system for each generator system.

Embodiments herein describe multiple ways to configure an electric aircraft with these AKERS electrical energy generation range extending systems. All systems can work together simultaneously or in various combinations to provide a constant high volume of charge sufficient to sustain an electric aircraft for distances of over 3500 miles without charging, e.g., when the electric aircraft is flying at speeds in excess of 300 mph. This means that this long-range aircraft can fly nonstop for almost 8 hours.

A first aircraft recharging electrical energy generator system (e.g., System 1) is configured to provide kinetic energy for recharging systems, and the first electrical machine generator is referred to as a Paddlewheel Air Brake (PAB). This first system includes at least the first PAB and a second high-speed generator unit that can operate in tandem.

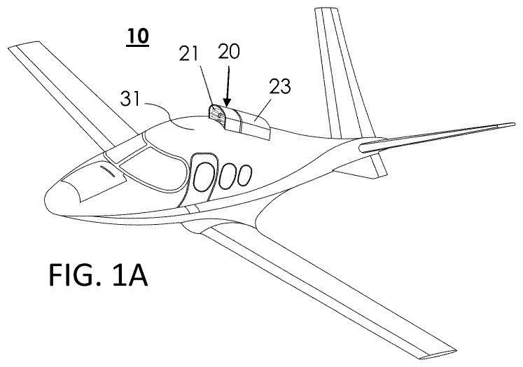

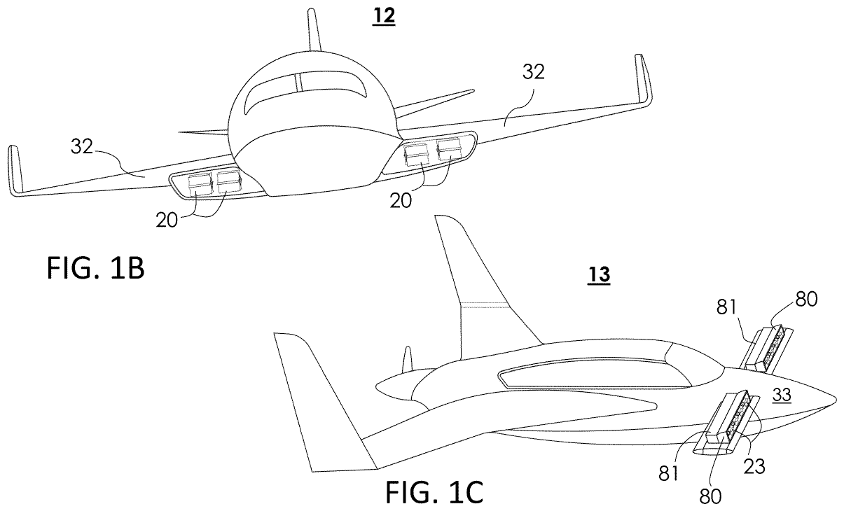

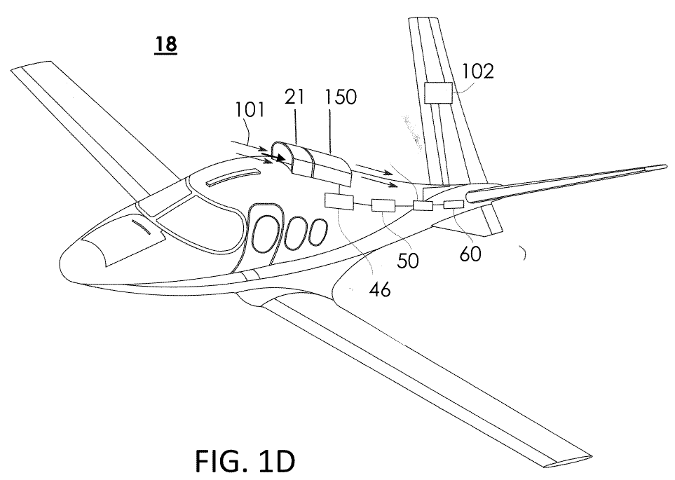

FIG. 1A is a view of an exemplary aircraft 10 depicting the placement of a first system (e.g., System 1) 20 including at least a first electrical machine generator and particularly, a Smart Concentrator Duct Inlet (CDI) 21 for receiving a fluid flow, e.g., air, in communication with a high-speed high efficiency paddlewheel generator, i.e., a Paddlewheel Air Brake (PAB) system 23 configured to provide kinetic energy for electric aircraft battery recharging systems. This first system 20 further includes: a charge controller including a combiner for receiving generated electrical energy, a smart ultracapacitor storage device, a gear multiplier, and a smart axle generator. A second high-speed generator can be additionally connected or engaged for further energy generation.

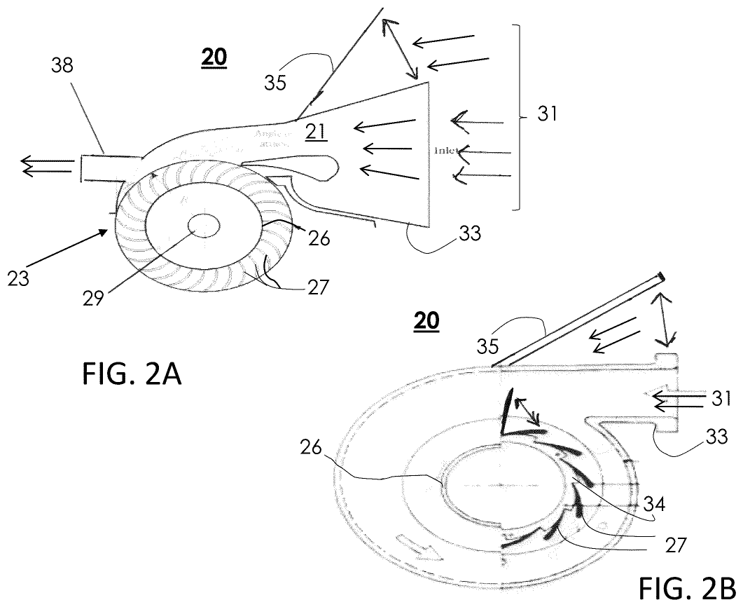

One or more CDI/PAB systems 20 can be attached to the aircraft in numerous places to maximize the fluid flow. As shown in FIG. 1A, the CDI 21 is mounted to the outside surface, such as a top surface 31 of the electric aircraft fuselage in such a way as to promote and capture fluid (air or wind) flow. In embodiments, the Smart Concentrator Duct Inlet (CDI) system 21 in FIG. 1A, is a computer controlled, adjustable concentrating ducting inlet which controls the flow of the subject fluid (air/wind) and includes a high-speed heat and warp resistant turbine for generating electricity. In one embodiment, as shown in FIGS. 2A, 2B the CDI 21 serves as the outside casing for the paddlewheel generator device which is designed so that it only exposes the top of the paddlewheel to the fluid (air) flow.

More particularly, as shown in FIG. 2A, as the aircraft operates, the fluid (air) enters the front of the CDI device and is forced through an hourglass shape casing that concentrates the force at an CDI outlet of the moving fluid and increases speed and pressure. This device is computer controlled to maximize the fluid (air) force on paddles 27 of the paddlewheel system 23. More particularly, a hardware processor-based or computer-based control system is configured to control the recharging system, e.g., in a normal operational state wherein the smart computer-controlled concentrator ducting inlet is adapted to gradually constrict the passage of fluid which increases the speed and pressure of the fluid. This process is optimized by the computer to maximize the flow. The CDI will use a Convergent divergent style nozzle to accelerate the fluid. The CDI also incorporates a computer-controlled flow regulator or programmable top flap portion that can be opened or closed to various degrees. The CDI is attached to the aircraft in such a way as to maximize the flow of fluids across the surface of the aircraft and direct that flow into a casing inlet. Once the aircraft is braking, landing, or decelerating the CDI automatically opens to its maximum setting to increase drag and friction which helps to slow the aircraft.

As further shown in FIG. 1A, the Paddlewheel Air Brake system 23 is a floating paddlewheel generator device that spins freely during aircraft flight to power a cylinder generator near frictionlessly. During braking, landing or deceleration, the device engages an air brake generator. The air brake generator system includes an axle connected to a smart gear multiplier that is connected to a second generator, i.e., a high-speed high output generator to help slow the aircraft with drag and resistance and create a large amount of charge at the same time.

FIG. 1B depicts a further embodiment of an aircraft 12 having lift wings 32 blow which are situated combined CDI/Paddlewheel Air Brake systems 20.

FIG. 1C depicts an embodiment of an airplane vehicle 13 having a PAB system paddlewheel generator including a CDI casing 80 shown situated at the front of the aircraft on either side of the nose 33 of the aircraft and depicting exposes paddles of the paddlewheel generator 23 that further connect to a further generator, i.e., a high-speed generator. In FIG. 1C, the high-speed generator housing 80 is an aerodynamic casing holding the PAB generator 23 and further a high-speed generator that generates additional electric power using the air fluid power. These two generator devices are connected and work in concert with each other. Together these two generators form a system (System 1) for generating power. FIG. 1C further depicts a rear exhaust opening 81 of the aerodynamic casing 100.

With more particularity, in the first electrical energy generator system (System 1), during aircraft braking, decelerating, or landing, a smart axle is engaged and activates the second electrical energy generator system. This second system is configured so that the axle is connected to a gear multiplier and high-capacity generator. The heavy gearing forces the axle to spin at a much higher speed and thereby creates a higher volume of charge while simultaneously creating more drag and resistance which aids in the deceleration of the aircraft. Each of the electrical machines are working together as an electric generator herein connected mechanically and electrically to the braking systems and the respective converted kinetic energy is supplied to the smart charge computer combiner smart ultra capacitor storage device. From there the power is used to recharge the batteries or power the aircraft directly. Once the aircraft is braking, landing, or decelerating the second generator on this device is automatically activated, the CDI opens to its maximum setting and the paddlewheel generator engages the smart gear multiplier. Now in addition to turning the rotor attached to the paddlewheel, the paddlewheel device is also turning an axle that is connected to the gear multiplier. This gear multiplier is connected to an axle which is connected to a high-capacity generator. The gear multiplier turns the axle at a much higher speed thereby creating the maximum charge in second electrical energy generator system, in addition the higher resistance and friction aids in slowing the aircraft. During the braking cycle the paddlewheel generator creates over twenty (20) times more current.

FIGS. 2A and 2B depict an example CDI/PAB electric generation system 20 can be situated at a variety of locations at the electric aircraft. In one operational state shown in FIGS. 2A, 2B, the fluid (air) enters the front of the CDI device 21 and is forced through an outer device casing 33 having an hourglass shape that concentrates the force of the moving fluid 31 and increases speed and pressure. The shape of the CDI is such that it encourages maximum fluid pressure and during braking increases drag. Further, as shown in FIGS. 2A, 2B, the fluid air 31 enters the opening of the CDI 21 and it is directed over the top of the floating magnetic bearing paddlewheel system 23 which forces the paddlewheel cylinder 26 to freely rotate about shaft 29. In an embodiment, the paddlewheel system includes a rotating cylinder about a shaft 29 having a floating magnetic bearing like assembly such that the cylinder can freely rotate about shaft. The top of the CDI 21 has an adjustable flap 35 that remains in a lowest (e.g., closed) setting for air travel and, under control of a computer or processor, is caused to increase to a maximum (i.e., opened) setting during deceleration and braking. During braking, landing, or deceleration the CDI flap 35 opens to the maximum position to increase drag, aid in braking, and maximize current. At a back end of the CDI is a rear exhaust port 38. Air flow is directed out the rear port 38 of the device. In the PAB device 23, there is provided plural adjustable paddles 27 on the rotatable 26 cylinder. The paddles on the paddlewheel cylinder adjust to multiple settings. The paddles remain in the lowest setting for air travel for maximum aerodynamics. The paddles are increased to the maximum setting during deceleration and braking to increase drag and power generation. In an embodiment, an outside gear 34 is connected to a 2^{nd} high-speed generator device.

Thus, in one embodiment, as shown in FIG. 2A, as the fluid enters the CDI system 21, it is directed over the top of the floating magnetic bearing paddlewheel which forces it to rotate. The shape of the CDI 21 is such that it encourages maximum fluid entry while maintaining aerodynamic efficiency while flying. During braking, landing, or deceleration, under computer control, the CDI opens to the maximum position to increase drag and maximize current.

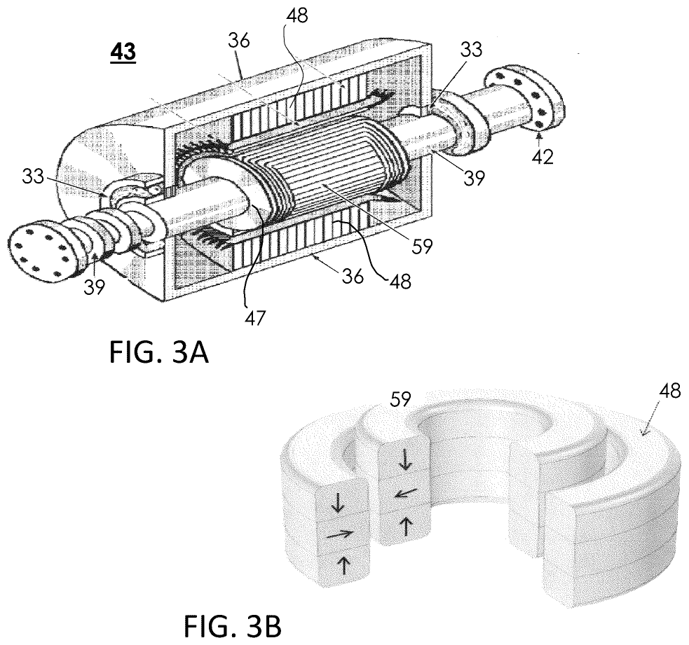

FIG. 3A shows an exploded view of an alternate embodiment of the Paddlewheel Air Brake Generator 43 that consists of: an outer magnet 48 connected to an inner surface of a rotatable paddlewheel housing (paddlewheel cylinder casing) 36 which casing encompasses a first paddlewheel generator. These outer magnets 48 are rotor magnets. A cylinder 47 situated on shaft 39 includes stator copper coils of magnets 59. When the housing 36 spins rotor magnets 48 induce a current in the stator coils 59 which current is directed to the smart combiner (not shown) connected to the axle/shaft that is rotatable about a magnetic bearing assembly 33. This inner copper coils 59 are attached to the shaft. Connected at one end of shaft 39 is a gear 42 that connects to a second high-speed generator (not shown). The shaft 39 supports the paddlewheel device and is connected to the second generator when engaged.

As shown conceptually in FIG. 3B, each inner magnet 59 is attached to the shaft and outer magnet is attached to the device. Each magnet has the same orientation and charge which causes them to repel each other and to suspend the device on a frictionless cushion of air.

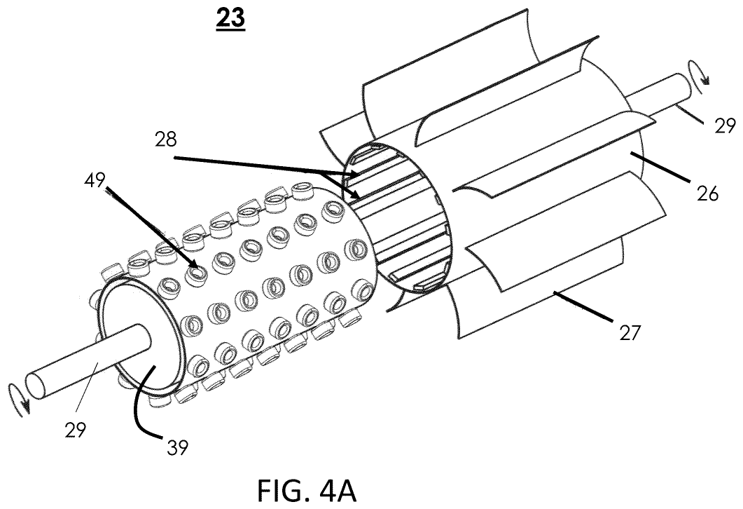

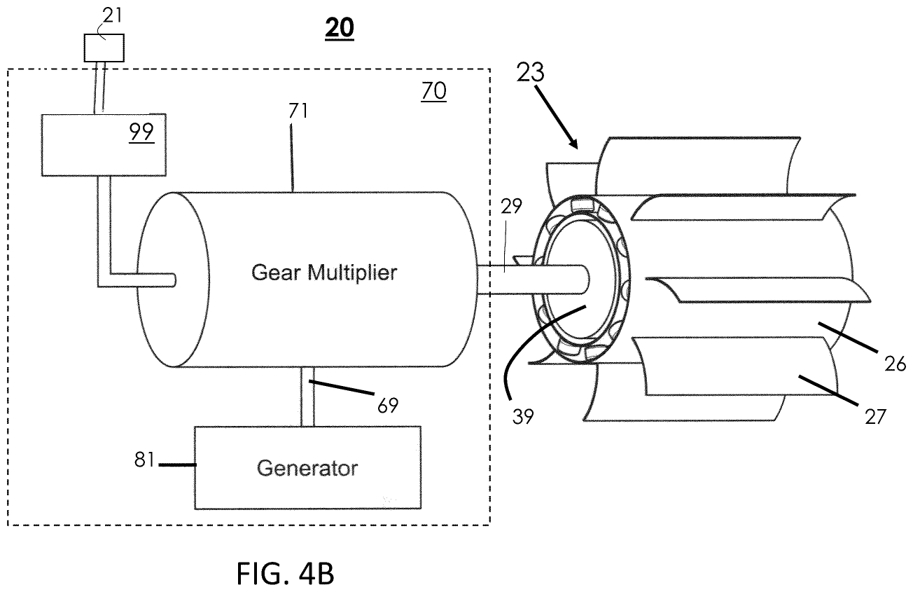

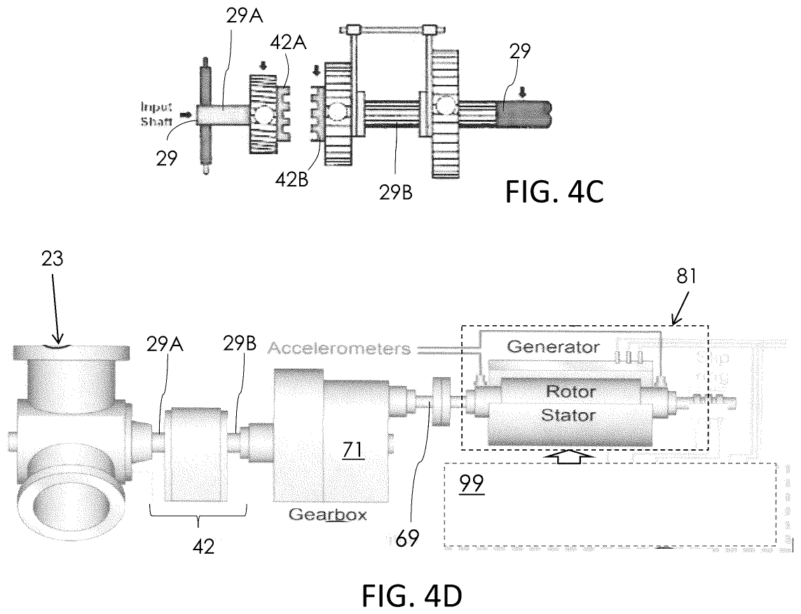

FIG. 4A depicts an exploded view of a further embodiment of the Paddlewheel Air Brake system 23. As shown in FIG. 4A, Paddlewheel Air Brake system 23 includes an outer cylindrical-shaped casing 26 with the plural paddles 27 affixed that rotate responsive to incident air flow received from the CDI inlet device (not shown). The inner wall of the casing 26 includes affixed metal conductors functioning as the rotor 28. A floating bearing-based magnetic axle 29 is attached to the casing to provide near frictionless rotation thereof. By placing magnets on the axle and the cylinder in parallel close proximity, it creates a magnetic floating axle. At the center of the casing 26 is situated a cylindrical-shaped stator 39 having a plurality of magnetic devices (e.g., copper coils) 49 protruding therefrom.

In each of the embodiments, CDI/PAB system 20 is configured to incorporate and operate two electrical energy generators combined to give maximum efficiency of the fluid flow. More particularly, the first Generator 1 (G1) is the PAB system 23 configured such that the CDI 21 is mounted to the outside surface of the electric aircraft in such a way as to promote fluid flow.

More particularly, in an example of a first-generation system (System 1), the device has two generators combined to give maximum efficiency of the fluid flow. The fluid from the CDI turns the paddle wheel cylinder which is used as the rotor. In the first PAB generator, the paddle wheel outer casing is floated using magnetic bearings. The rotor is positioned on the inside wall of the cylinder which houses either copper windings or magnets. The paddles affixed to the outside of the cylinder force the cylinder to spin around the center stator 29. The outside casing is also connected to a smart axle which is disengaged during flight and taxying, allowing the floating supports to spin frictionlessly at a high speed. The airflow over the paddlewheel powers the first PAB generator of the two-generator system included in this device by turning the paddlewheel of the high-speed high efficiency paddlewheel generator which rotates a rotor around a stator and creates charge. The current is then directed to a smart charge computer combiner which accepts multiple power inputs from several devices and concentrates them into a single voltage and current. This current is then directed into a smart ultracapacitor storage device that is designed to handle high voltage and current.

In an embodiment of the PAB, as shown in FIG. 2A, 4A, at the aircraft the air/wind then enters the CDI 21 and is directed over the top of a floating paddle wheel cylinder(s) in a wide thin high pressure stream during flight and taxiing. The paddle wheels and outer casing 26 are floated using magnet bearings. The fluid turns the paddle wheel cylinder which is used as the rotor. The rotor is positioned on the inside wall of the cylinder 26 which houses either copper windings or magnets. The paddles 27 affixed to the outside of the cylinder force the cylinder to spin around the center stator 39. The spinning rotor induces a current in the stator which is directed to the combiner. The outside casing is also connected to a smart axle which is disengaged during flight and taxying, allowing the floating supports to spin frictionlessly at a high speed.

FIG. 4B depicts an operation of a second high-speed generator system 70 connected to the Paddlewheel Air Brake generator system (first generator system) 23. As shown in FIG. 4B, second high-speed generator system 70 includes a gear multiplier 71 adapted to engage the axle or output shaft 29 of the Paddlewheel Air Brake system 23 and further connects to high-speed generator 81 via a second shaft 69. As shown in FIG. 4B, in operation, upon conversion of the kinetic energy to energy producing motion of the shaft 29, the gear multiplier 71 engages shaft 29 and turns the second shaft (axle) 69 to spin a rotor (not shown) in a high-speed generator 81. The spinning rotor in generator 81 induces a current in a stator (not shown) which is directed to the combiner. During landing or braking the paddlewheel generator axle 29 engages and spins the smart gear multiplier 71 which results in the turning of shaft 69 to generate electric power at generator 81 that can be directed to the combiner for storage.

More particularly, in view of FIG. 4B, during aircraft braking, decelerating, or landing, the second generator 81 (G2) is activated. During braking, decelerating, or landing the smart axle 29 is engaged and the CDI system 21 is opened to the maximum configuration to increase drag which aids in deceleration and to increase air flow for maximum charge. Under control of a computer or hardware processor 99, the CDI 21 is controllable such that the top flap portion of the CDI is designed to open to various levels depending on the requirements of the aircraft. During normal flight the computer keeps the CDI flap at the lowest setting to increase aerodynamic efficiency. During braking and deceleration, the computer opens the flap to the maximum setting to increase drag and power generation. The computer controls the paddles. During normal flight the computer keeps the paddles at the lowest setting to increase aerodynamic efficiency. During braking and deceleration, the computer opens the paddles to the maximum setting to increase drag and power generation. The computer further 99 engages the gear multiplier 71 which is connected to the high-speed generator 81. During normal flight the computer disengages the second generator 81 to allow the paddle generator to float and spin near frictionlessly on their magnetic bearings to reduce drag and friction which improves flight efficiency. During braking and deceleration, the computer engages the gear multiplier to shaft 29 of first PAB generation system 23 which drives the shaft 69 and activates the 2^{nd} generator 81 via the shaft 69 connected to the gear multiplier 71. These actions result in increasing drag and friction which aids in slowing the aircraft and maximizing power generation.

FIG. 4C depicts the engagement of the second (high-speed) generator with the first PAB generator system via engaging shaft 29. The output shaft 29 of the first generator PAB system includes portion 29A which engages a corresponding input shaft portion 29B of the second (high-speed) generator system 70. More particularly, in FIG. 4C, a gear 42A situated on input shaft portion 29A engages or enmeshes with gear 42B of output shaft portion 29B connecting to gear multiplier 71 (not shown) which connects to the high-speed generator 81 (second generator). During normal flight operation, the two gears 42A, 42B are separated and therefore not engaged. During landing or breaking the smart computer 99 causes engagement of the gears of 42A, 42B of the two shaft portions 29A, 29B and the shaft 29 is engaged and the force of the shaft rotation is multiplied at gear multiplier 71 (not shown) for rotating the output shaft 69 of the second generator system (not shown) of FIG. 4B.

FIG. 4D depicts an alternative view depicting an engagement of the gear multiplier 71 of a second high-speed generator system including rotor stator design to the first PAB generator system 23. There is shown in FIG. 4D the shaft portions 29A, 29B having respective gears shown engaging each other 42 using computer control actuators (not shown). During normal flight the two gears 42 are separated and therefore not engaged. During landing or breaking the smart computer 99 engages the device and the two gears 42 are connected and the shaft 29 is engaged and the force of rotation is multiplied at gearbox 71 which increases the rotational speed of the output shaft 69 generating electricity from rotor stator interaction at the generator 81.

In this embodiment, when engaged, the heavy gearing in gear multiplier 71 creates a high volume of charge and creates drag and resistance which aids in the deceleration of the aircraft. Each of these electrical machines: first PAB generation system 23 and second high-speed generator system 70 are working together as a single electric generator herein connected mechanically and electrically to the aircraft braking systems and the respective converted kinetic energy is supplied to the smart charge computer combiner smart ultra capacitor storage device. From the stored charge, power can be generated under computer control to recharge the batteries or power the aircraft directly.

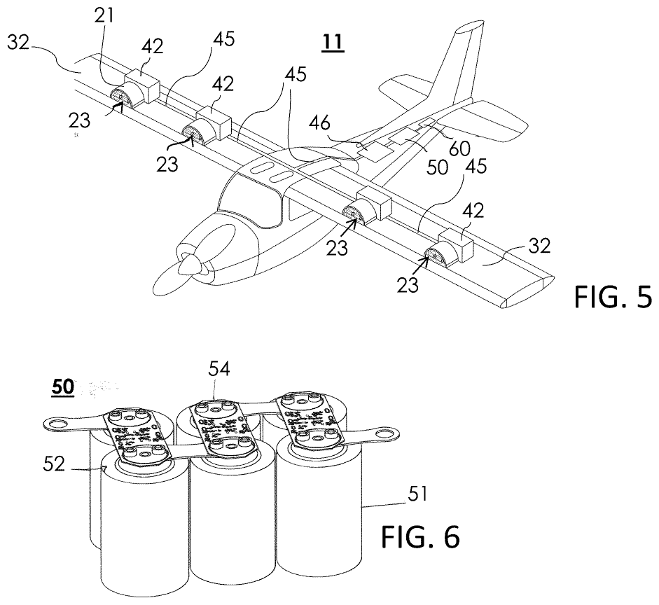

FIG. 5 shows a configuration depicting several Paddlewheel Air Brake generation systems 23 on an airplane vehicle 11. As shown in FIG. 5, on top of the aircraft's lift wings 32 are located several electrical energy PAB recharging systems 23, each recharging system 200 including a respective CDI system 21, one or more GAT generators situated within an air brake generator housing 42, and an electrical power conductor or bus 45 that carries the current produced by generators of each system 200 to a smart charge computer combiner 46 which receives current from each of the various systems 200 and directs the current to a smart self-cooling ultracapacitor 50 which then feeds the current directly to a charge storage system or directly to the aircraft battery or battery bank 60 through a relay (not shown). Here, current from PAB generator (G1) is directed to the smart computer combiner device 46 over electrical conductor or power bus 45. Further, current from high-speed generator (G2) is directed to the smart computer combiner device. 46 over the bus 45. The smart computer-controlled combiner device 46 controls the CPI, the paddles, and the engaging assembly for the gearbox. It also monitors the output and other features of generators G1 and G2. In cases of overcharging or overheating the smart computer can disengage both devices. The smart computer directs the charge to the smart combiner which corrects the current and voltage from all devices and combines them into a single current. A smart self-cooling ultracapacitor 50 can receive and deliver the current and can accept high voltage and charge quickly. It accepts the current and directs it to the right area at the proper voltage and current. It monitors that process to ensure maximum efficiency. It can then later trickle charge the current to the battery or battery bank 60 or fast charge another aircraft midair.

FIG. 6 shows a configuration of smart self-cooling flash ultracapacitor storage device 50 for use in the systems of FIG. 5 that include: an outer carbon ceramic self-cooling casing 51 which casing 51 is designed to force heat to the surface where it can me cooled quickly; and an inner heat sink fluid flow enclosure area 52 which area is composed of heat sinks that are directly attached to the capacitor 50 and provide maximum surface area for cooling. Computer-controlled Integrated circuit devices 54 are provided to monitor and control all smart functions of the ultracapacitor device. In FIG. 6, the self-cooling flash ultracapacitor storage device has an outer layer that is comprised of a carbon ceramic polymer that dissipates heat quickly, the outer layer has a heat sink molded to the shape of the device that further cools the device.

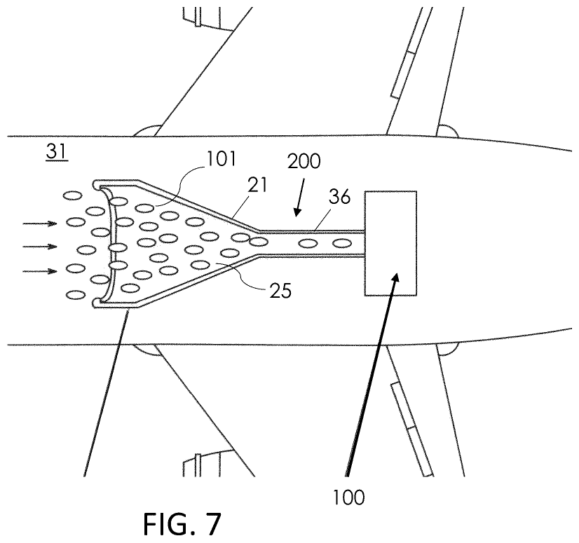

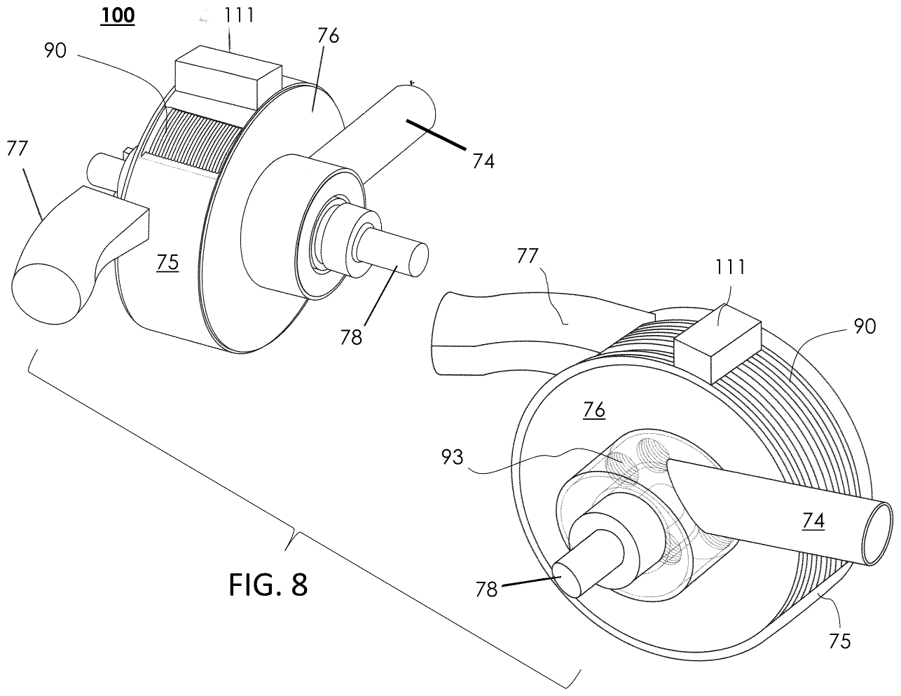

FIG. 7 depicts a portion of an airplane vehicle having further electrical recharging system 200 referred to as the Grayson Air Turbine (GAT) with Exhaust Cone Generator (ECG) device 100 shown situated on the aircraft fuselage surface.

As shown in FIG. 7, further energy generation system 200 for electric aircraft includes the CDI 21 inlet connection attached to the aircraft fuselage surface 31, however, it is understood the CDI and generator system(s) can be located in numerous locations at the surface of the plane to maximize the fluid flow. The fluid 101 (i.e., air or wind) enters the front of the device 21 and is forced through the hourglass shaped housing 25 that concentrates the force of the moving fluid through a slimmer housing outlet portion 36 and increases speed and pressure of the fluid. This turbine device 100 is computer controlled to maximize the viscous force applied to a disc (described in greater detail below). As the fluid enters the CDI 21 it is directed to the casing inlet. The shape of the CDI is such that it encourages maximum fluid pressure. The Grayson Air Turbine with Exhaust Cone Generator device 100 is depicted in housing that receives the fluid flow 101 from the CDI 21.

FIG. 8 depicts two perspective views of the Grayson Air Turbine (GAT) system 100. In view of FIG. 8, in operation, an air flow enters the CDI 21 and is fed into the GAT turbine device 100 which spins discs 90, mounted on and which in turn spin an axle 78 at the center of the turbine, and this spinning axle can rotate a magnet through a copper field. This copper field produces electricity which is diverted to the charge controller which either powers the vehicle, is stored, or recharges a battery bank. This entire device is controlled by a computer-controlled power management system that monitors the entire operation for efficiency, performance, and optimization.

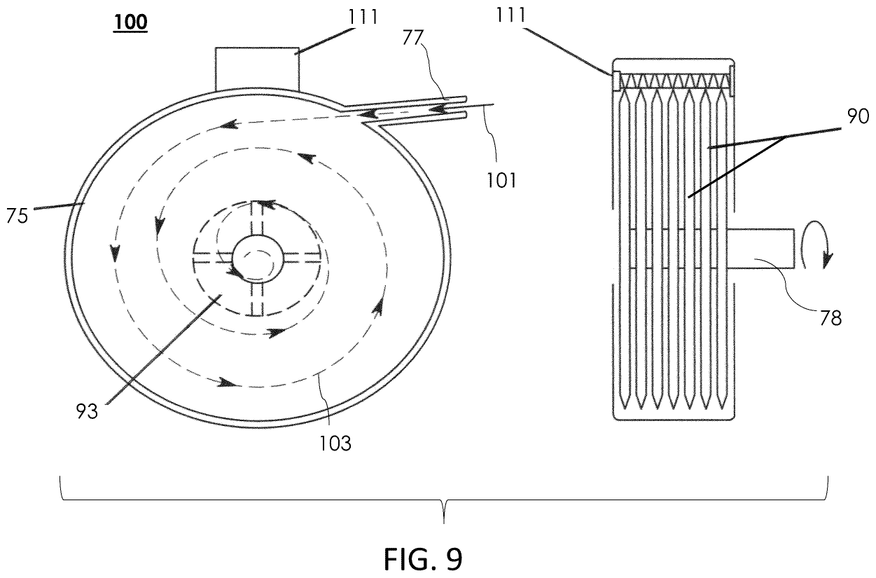

In the view of FIG. 9, an outer turbine casing 76 has an exhaust port 74 which connects to an Exhaust Cone Generator inlet (not shown) . . . . In an embodiment, casing 75 holds several heat resistant discs 90 that are spaced such that they maximize flow and minimize resistance to inlet air flow. This spacing is controlled by a computer-controlled Smart Electronic Shim Spacer (SESS) 111. The outer casing 76 holds thin heat- and warp-resistant spiral etched discs (not shown). The casing 75 has an inlet 77 for the fluid flow from the CDI. The casing 75 houses an axle 78 which is mounted in the center of the device 100 and is connected to the discs 90. This axle spins a rotor. In an embodiment, SESS device spaces the discs based on maximum disc rotation which is a function of the viscous drag effect on the discs cause by the fluid flow between them. If the discs are too close, they will cancel or slow the rotation effect. The opposite is true if the discs are too far apart. In addition, the SESS monitors disc wear, heat and vibration. Therefore, optimal distance is measured, monitored, and controlled by the SESS. The SESS is controlled by a smart computer which is located at the top of the device that electronically controls the distance between the discs. The SESS is a screw like device that has a microprocessor connect to the top of the device to control connections, house sensors for monitoring and controlling disc operations to increase their maximum efficiency and to avoid overheating, nonoptimal friction and wear.

In an embodiment, GAT device 100 takes advantage of the viscous effect of fluids on a solid surface. The viscous effect happens when the air is injected by the CDI into the inlet which is designed to send the air to the disk's edge. Due to viscosity, the shape of the casing, the spiral etching and adhesion, the injected air spirals inward over the disk, forcing it to revolve. The air fluid exits through exhaust hole sections around the shaft. The exhaust air exits the disc rotor through the exhaust port where it is captured by a second generator (inlet the second generator). When fluid exits the CDI, the fluid enters the outer casing tangential to the casing. The outer casing 76 holds the discs. Upon the fluid entering the inlet 77 to the outer casing the interaction between the fluid and the disc(s) will cause the disc(s) to spin. The spinning discs are connected to a shaft 78 which can spin as a rotor in a generator and create electricity. Provision for the fluid to leave the casing is at the center 93 of the turbine. Inlet fluid with higher pressure than the atmosphere is entering the inlet nozzle and exit the hole at atmospheric pressure. The greater the disc speed the more the fluid particles move away from the center as a result of centrifugal forces forming a spiral pattern of travel which increase the contact area of the fluid thereby increasing the viscous force on the disc, which in turn increases the RPM of the shaft 78, which produces more electricity. The faster the turbine rotates the more energy it extracts from the fluid which creates greater RPMs at the shaft.

The outer casing contains multiple circular disc that are approximately 0.4 mm apart in one configuration, but the distance will vary based on configuration and design. These thin discs are constructed of anti-warp heat resistant materials. The disc takes advantage of the boundary layer effect. The device is constructed so that the turbine and fluid work in the same plane. The casing takes advantage of the low-pressure exhaust which draws the fluid to the discharge port and smoothly guides the fluid to the exhaust port. The discharge ports are placed at the lateral part of the casing toward the center. At the center of the device is the axle 78. This device becomes a rotor. This rotor is a simple axis with several thin disc arranged at an optimal distance to reduce drag forces. Placed inside the casing right at the center of the vortex. The discs 90 are designed to draw the fluid to the exhaust port. The discs have incorporated spacers which create paths to guide the air to the center exhaust hub. The discs are arranged in a stepping staircase design which helps to create a vortex in the device. This device uses front and rear cover with exhaust ports, and turbine disc with holes in the center for exhaust.

In particular, FIG. 9 depicts two exposed inner views of the Grayson Air Turbine 100 showing the discs 90 in spaced apart configuration within the housing to reduce drag responsive to received input air flow 101 from the CDI. A Smart shim spacer 111 is provided to control the distance between individual discs 90. In an embodiment, the device housing 75 is designed to force the fluid (received air flow) into a circular flow 103 inside the turbine device 100 which forces the spiral etched discs to spin. The discs 90 are attached to an axle 78 which is forced to rotate by the spinning of the discs 90 responsive to forces and pressure of the circular fluid flow inside the device. The discs 90 each have exhaust holes 93 located at their center to allow the fluid to exit the device through the exhaust port.

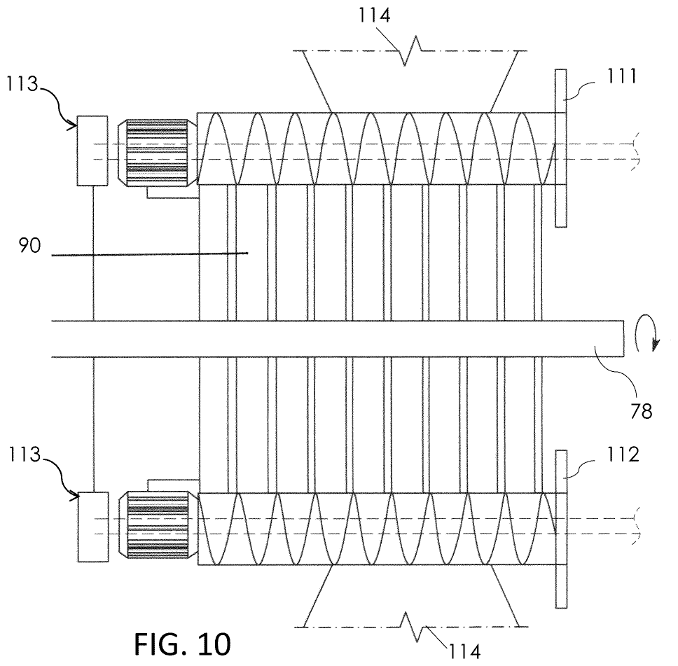

FIG. 10 depicts a further exposed inner view of the Grayson Air Turbine 100 showing the discs 90 rotatable about axle 78 in spaced apart configuration as programmed using shim spacer 111 within the housing to reduce drag responsive to received input air flow. Additionally depicted in FIG. 10 is a second shim spacer 112, spacer device motors 113, spacing screw devices 114.

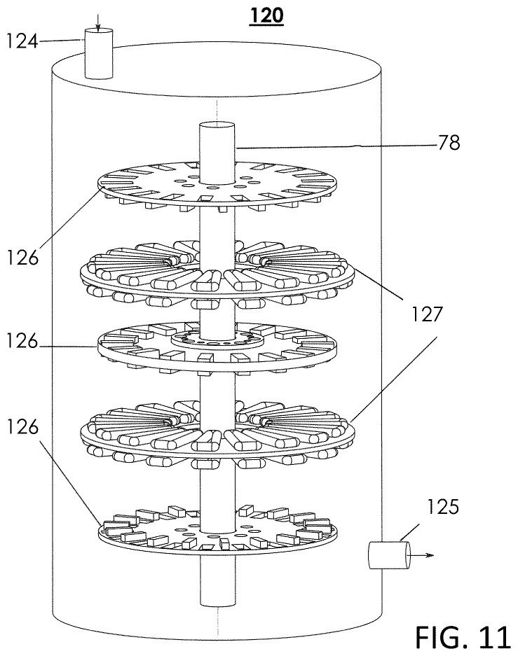

FIG. 11 depicts an internal view of a further electric energy generator system referred to as a fluid cooled flat pancake generator 120 that is driven by the shaft 78 connected to the spinning discs at the GAT turbine 100. In FIG. 11 an air inlet 124 provides air input from the CDI, for example, to air cool the generator. An air exhaust outlet 125 is provided to exhaust the air from the device to an inlet of a further generator device (not shown). Generator device 120 of FIG. 11 further depicts. an flat pancake configuration of rotors/stators rotatable about axle 78 for generating electricity that includes rotors 126 and intervening stator elements 127. Here, the rotor is turned by the axle 28 which is connected to the rotating discs of the GAT 100. The stator 127 is a copper coil stator is not connected to the shaft axle 28.

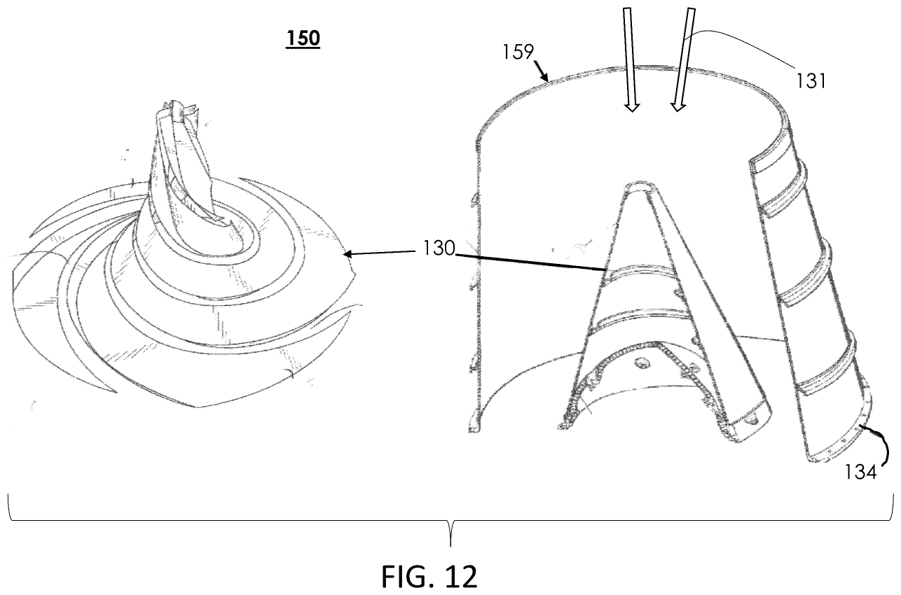

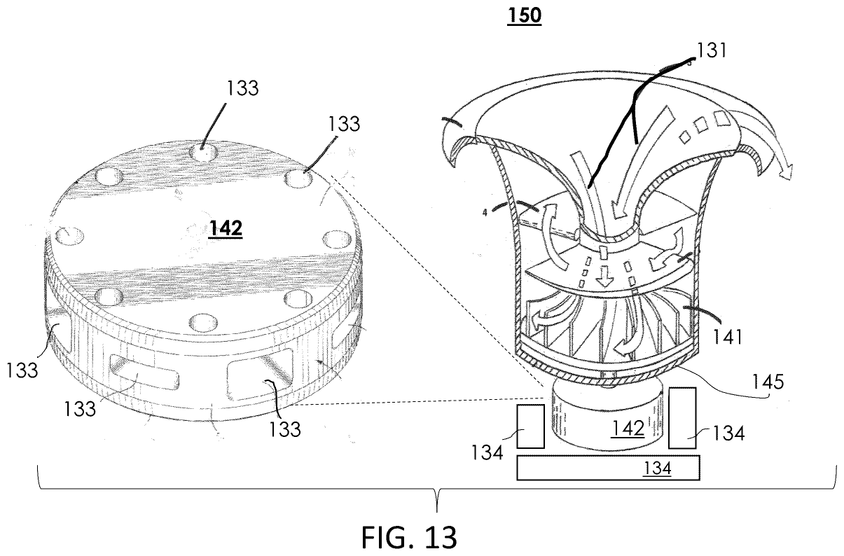

FIG. 12 depicts further aircraft range extending cone generator (ECG) system 150 that is connected directly to the GAT 100 of FIG. 8. In FIG. 12 an outer casing 159 that connects to the exhaust port 74 of the GAT turbine 100 of FIG. 8 to receive exhaust airflow 131 therefrom. That is, the exhaust air from the GAT is fed through this generator to maximize the charge created by the fluid flow. The air exiting the GAT is still highly pressurized and therefore is an excellent source of additional kinetic energy.

A center spiral device 130 channels the air flow 131 downward and outward. As the fluid flow enters the chamber it is forced down the spiral shaped cone 130. As shown in FIG. 13, the air flow 131 that is forced down the device casing 159 impinges upon of the paddle vents 141 to cause a circular base element or rotor 142 of the device to spin. The air flow is forced to exit the device at a bottom end through paddle vents 141 located at the base of the cone 130. These paddle vents 141 allow the fluid to escape but at an angle to the device. By forcing the pressurized air to leave at an angle, the exhaust air forces the base of the device 150 to rotate.

As shown in FIG. 13, the spinning turns the rotor 142 which houses magnets 133 situated on the side, bottom and top of the rotor device 142. Referring to FIG. 13, casing 159 includes a copper winding stator 134 on the inside of the casing at the base where the magnets on the side of the rotor induce current by interaction of magnets 133 of rotor device 142 with stator copper windings 134. As further shown in FIG. 13, copper winding stator 134 is depicted at the bottom 145 of the device where magnets on the top of the rotor induce current. In an embodiment, the base 142 of the device house magnets on the side, top and/or bottom which are parallel to the stators 134 that are positioned close to the rotor magnets. This spinning turns the rotor which houses magnets on the side, bottom and top of the device.

With more particularity, the high-speed high efficiency heat resistant warp resistant fluid turbine generator type range extender and recharger for electric aircraft receives the fluid (air) pressure leaving the exhaust which is forced down the spiral cone shaped device which then exits the cone shaped device through a series of paddle winged 141 and angled openings at the base of the device. The fluid leaving the device pushes on the winged paddle angle openings and forces the base to rotate. This rotation turns the rotor base 142. The rotor base 142 of this device has magnets 133 on the side, top and bottom which interact with fields created by three copper coil stators which are parallel to the rotor magnets and affixed to the device. As the base 142 spins, the magnets spin, creating electricity in the copper coils which power the generator such that the permanent magnets pass through the coil field of the copper wire where electricity is produced. This copper field produces electricity (a charge is created in the copper windings) which is directed to the combiner under control of the smart charge controller which either powers the vehicle or is temporarily stored in the smart ultracapacitor so that it can trickle charge the battery bank. This entire operation is controlled by a computer control system that monitors the entire operation for efficiency, performance, and optimization. This ECG generator system 150 thus uses the spiral shaped conical device to direct the exhaust fluid flow down the center spiral and out of the base of the device, before exiting the aircraft, which has winged openings that force the base of the device to spin. The base of the device has magnets attached to the sides, the top and bottom, that spin around the copper windings located in the outer casing of the device and parallel to the magnets. The spinning of the base creates a charge in the copper windings which is directed to the combiner.

In view of FIGS. 7-13, a two-generator system including a pancake generator system 120 (G1) and the ECG generator 150 (G2) is powered by a single stream of air flow from the CDI. The first generator system, G1, includes a GAT turbine 100 that receives air flow from the CDI that allows a narrow stream of highly pressurized air flow to be direct into an inlet attached to a casing that houses a series of very closely packed parallel high-speed heat and warp resistant spiral etched disks which are attached to a shaft and arranged within the sealed casing chamber. The pressurized air forces the circular disc 90 to spin rapidly during flight, which in turn spins the shaft, which in turn spins the rotor in the first generator system and creates electricity. Once the aircraft is landing or decelerating the CDI opens to the maximum setting to help slow the aircraft by increasing drag and to allow for the maximum airflow into the casing chamber which greatly increases the amount of electricity produced. Once air is forced into the chamber the disc takes advantage of the viscous effect of fluids on a solid surface. When fluid enters the CDI, the fluid enters the outer casing tangential to the inner casing. The outer casing holds the discs the inner casing holds the spiral cone generator of a second generator system. Upon the fluid entering the inlet to the outer casing the interaction between the fluid and the disc will cause the disc to spin. The spinning discs are connected to a shaft which spins the rotor in the generator and creates electricity. Provision for the fluid to leave the casing is at the center of the turbine. The air that exits the center of the turbine is then redirected to the second generator, or exhaust generator. Inlet fluid with higher pressure than the atmosphere is entering the inlet nozzle and exiting the hole at atmospheric pressure. The greater the disc speed the more the fluid particles move away from the center as a result of centrifugal forces forming a spiral pattern of travel which increase the contact area of the fluid thereby increasing the viscous force on the disc, which in turn increases the RPM of the shaft, which produces more electricity in the first pancake generator G1 system 120. The discs are etched with a spiral pattern to promote this spiral movement.

The faster the turbine rotates the more energy it extracts from the fluid which creates greater RPMs at the shaft. When the fluid enters the chamber and passes between the disks, the disks turn, which in turn rotates the shaft. This rotary motion is used to power a pancake generator such as shown in FIG. 12. The closely packed disks are separated and controlled by a smart computer controlled electronic shim spacer (SESS) that electronically controls the distance between the discs to increase their maximum efficiency and to avoid overheating, nonoptimal friction and wear. In an embodiment, a hardware-processor based, or computer-based control system is configured to control and monitor the smart electronic shim spacer. The computer-controlled CDI is designed so that it gradually constricts the passage of fluid which increases the speed and pressure of the fluid. This process is optimized by the computer to maximize the viscous force on the disc.

In an embodiment, the CDI includes a convergent/divergent style nozzle to accelerate the fluid. The CDI also incorporates a computer-controlled flow regulator, in the form of flap 35. The disc takes advantage of the boundary layer effect. The device is constructed so that the turbine and fluid work in the same spatial plane. The casing device takes advantage of the low-pressure exhaust which draws the fluid to the discharge port of the GAT and smoothly guides the fluid to the exhaust port. The discharge ports are placed at the lateral part of the casing toward the center. At the center of the device is an axle. This device becomes a rotor. This rotor is a simple axis with several thin discs arranged at an optimal distance to reduce drag forces. Placed inside the casing right at the center of the vortex. The discs are designed to draw the fluid to the exhaust port where it can be directed to the second generator system (G2) or ECG system 150. The discs have incorporated a spiral etching and uses the electronic shim spacer which helps create paths to guide the air to the center exhaust hub casing. The discs are arranged in a stepping staircase design which helps to create a vortex in the device. This device uses front and rear cover with exhaust ports, and turbine disc with holes in the center for exhaust.

The first pancake generator system G1 is powered by a rotor that is connected to a rotating axle that is connected to several discs which are housed in the casing where the discs are forced to spin by the boundary layer effect of fluid on the surface of the disc, said fluid which is forced through the casing inlet. A computer-controlled CDI which is attached to the aircraft in such a way as to maximize the flow of fluids across the surface of the aircraft and direct that flow into the casing inlet. A casing which holds several thin heat and warp resistant discs which have vent holes. These discs are spaced so that they minimize drag. These discs are arranged in the casing so as to create a vortex within the casing that increases the rotational energy of the axel. The spacing is controlled by a SESS. A charge controller which directs the flow of electricity either to the vehicle or the smart charge computer ultracapacitor then the battery bank. The high-speed high efficiency heat resistant warp resistant fluid turbine generator type range extender and recharger for electric aircraft.

Referring to FIG. 1D there is depicted a configuration of an electric aircraft 18 equipped with Grayson Air Turbine (GAT) with Exhaust Cone Generator (ECG) for generating current flow. In FIG. 1D, computer-controlled CDI device 21 controls the top flap of the device which can be raised to multiple levels. It controls the inner constriction and air flow 101 to the device and it assists with braking when the flap is open. The CDI outlet feeds the (GAT) coupled with the Pancake generator system 120 and feeding the Exhaust Cone Generator (ECG) system 150. This two-generator system is powered by the air flow 101 from the CDI. The smart computer or processor 99 controls and monitors all functions of the two generator systems. The generated currents are received at the smart combiner 46 which device combines the charge and current from multiple recharging devices into a single charge and current. The charging current from combiner 46 is input to the smart ultracapacitor 50 which device controls the input and output of current, and enables fast charging of the aircraft battery system or battery bank 60. Ultracapacitor device 50 can additionally trickle charges the battery 60. Further, it is used to control the A2A recharging functions and gives each system the appropriate voltage and charge required by that system. As shown in FIG. 1D, aircraft 18 includes A2A receptacles 102. This device either deploys the recharging boom or allows another aircraft to connect to the aircraft charging system with their compatible boom.

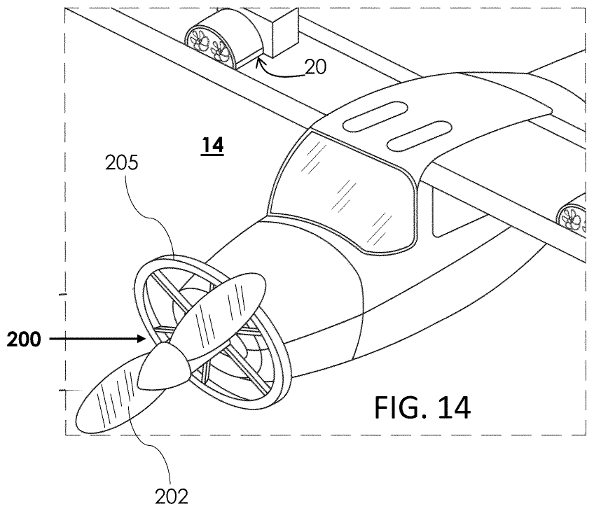

FIG. 14 shows an electric aircraft 14 including a blade-based rotor stator energy generation system 200 situated at the nose of the plane 14 in the non-limiting embodiment depicted. Depicted is the relative placement of the rotor 202 and stator 205 on the blade drive shaft of the aircraft. In the embodiment of FIG. 14, the rotor 202 is positioned near the end of the drive shaft at the nose of the airplane. In this embodiment, the rotor is the aircraft blade 202 and is affixed with either magnets or copper coils depending on the configuration to serve as the rotor. The device stator 205 is affixed to the aircraft 14 such that it is very close to the rotor blade 202, e.g., is positioned behind the rotor blades and connected to the aircraft and is affixed with either copper coils or magnets depending on the configuration to serve as the stator housing. As the propellor blade is powered up and begins to spin it in turn spins the copper windings or magnets near the stator. This spinning motion causes a current to be induced in the copper windings at the stator.

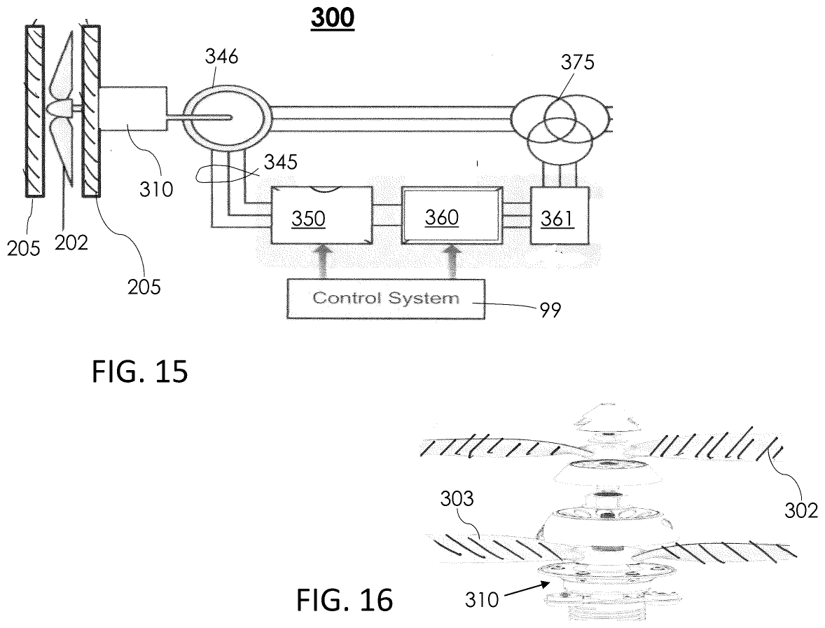

FIG. 15 depicts a Grayson Blade Rotor Generator assembly 300 of an electric aircraft vehicle. In FIG. 15, the propellor blade 202 is affixed with either magnets or copper coils depending on the configuration. This serves as the rotor and is shown connected to a drive shaft and gearing assembly 310. The stator 205 is positioned behind the rotor blades and optionally, or in addition, or in front of the propellor blade (rotor) 202. The stator 205 is connected to aircraft and is affixed with either copper coils or magnets depending on the configuration to serve as the stator. The stator and is positioned close enough to the rotor so that the E-fields and magnet fluxes interact to induce a current in the copper field. In an embodiment, the current is then directed to the smart computer combiner 346. The current leaves the smart computer combiner 346 and is stored over the bus 245 to the smart ultracapacitor 350. From the ultracapacitor 350, the charge can be directed to the battery 360 or battery bank 361 all under control of the computer or processor control system 99. From the battery bank 361, the charge can power the aircraft. The ultracapacitor 350 also feeds an air-to-air recharging system 375. This system allows other aircraft to be fast charged from the ultracapacitor. The fast charging receptacle can feed power to the ultracapacitor or feed power to another aircraft

FIG. 16 depicts a dual propellor blade system including blades 302, 303 shown connected to a drive shaft and gearing assembly 310. Here, the propellor blade 302 is affixed with either magnets or copper coils depending on the configuration to serves as the rotor. The stator 303 is positioned behind the rotor blades and or in front of the propellor blade. The stator 303 is connected to aircraft and is affixed with either copper coils or magnets depending on the configuration to serve as the stator. The stator and is positioned close enough to the rotor so that the E-fields and magnet fluxes interact to induce a current in the copper field.

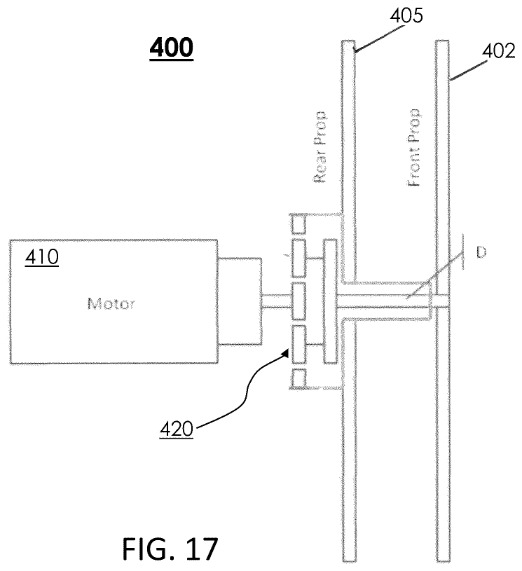

FIG. 17 depicts a Grayson Blade Rotor (GBR) generator assembly 400 configured as a, Dual blade charge generation system. In FIG. 17, the dual blade system 400 includes blades 402, 405 shown connected to a drive shaft and motor assembly 410. In one embodiment, the blade 402 is a rotor and is affixed either magnets or copper coils depending on the configuration of which blade 402 is to serve as the rotor. In an embodiment, the blade 405 is a stator and can be a contra rotating stator (rotating contrary to the rotation of the rotor) and is configured with either copper coils or magnets (not shown) attached to the surface of the blade. Here contra rotation of the rear propellor blade 405 stator has copper windings on the surface of the blade facing the front propellor 402. Contra-rotation is derived by the power from the motor assembly 410 being transferred to the propellers 402, 405 using a planetary gear-based or spur gear-based transmission device 420 for contra-rotation thereof.

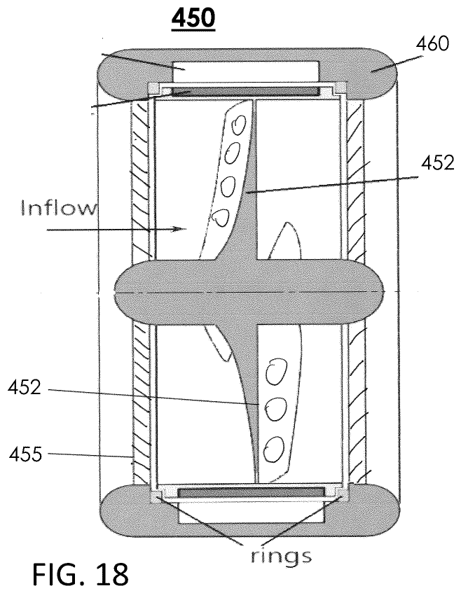

FIG. 18 shows a further embodiment of a Grayson Blade Rotor Generator assembly 450. In this embodiment, the stator can be positioned both in front of and behind the propellor blade rotor in a ducting assembly 460 for aircraft and watercraft with fluid inflow (air or water) shown. Here, the propellor blades 452 further function as rotors. Propellor rotors with magnets or copper coils (not shown) mounted on the surface of the propellor blade depending on configuration are facing the stator 455 and close enough to the stator to induce a current. The stator 455 is circular and is mounted to the duct housing have copper coils or magnets mounted on the surface of the device depending on configuration.

In the third electrical generation systems (System 3) depicted in FIGS. 14-17, there is provided at least one stator ring, at least one blade rotor, armature windings, magnets, and a smart charge controller and sensors. System 3 turns the aircraft spinning blades 202, 402 into a rotor. In the blade charge generation system of FIGS. 15-16, the rotor (blade) spins the copper windings or magnets mounted on the blade near at least one circular stator 205, 405 positioned behind the rotor. This spinning blade rotates a magnet through a copper field. This copper field produces electricity which is diverted to the charge controller combiner which either powers the aircraft or recharges the battery bank. In the dual blade charge generation system of FIG. 17, the system uses a dual blade contra rotating system. This twin counter rotating blade system uses one blade 402 as the rotor and the other blade 405 as the stator. This configuration generates the maximum power, and the entire device is controlled by a computer control system that monitors the entire operation for efficiency, performance, and optimization.

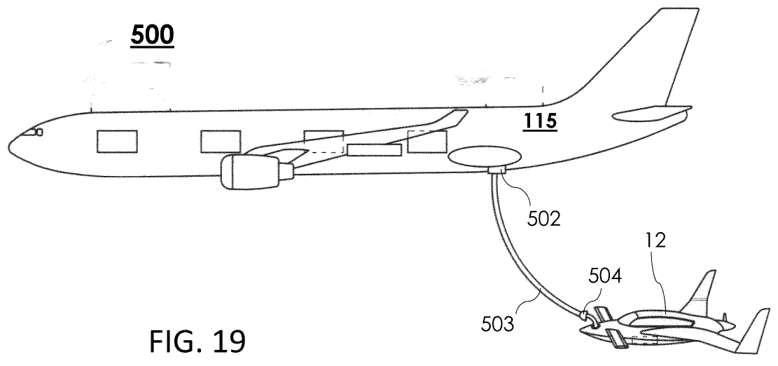

FIG. 19 depicts an exemplary Air-to-Air (A2A) electric aircraft charging/recharging system 500 for an electric aircraft 115. The aircraft 115 includes an example charging deployment for the A2A system and includes a recharging receptacle 502 for storing boom 503 and attached probe 504 adapted for insertion into a receiver charging receptacle of another charging aircraft 12 in the A2A system for receiving a battery re-charge at the aircraft 115.

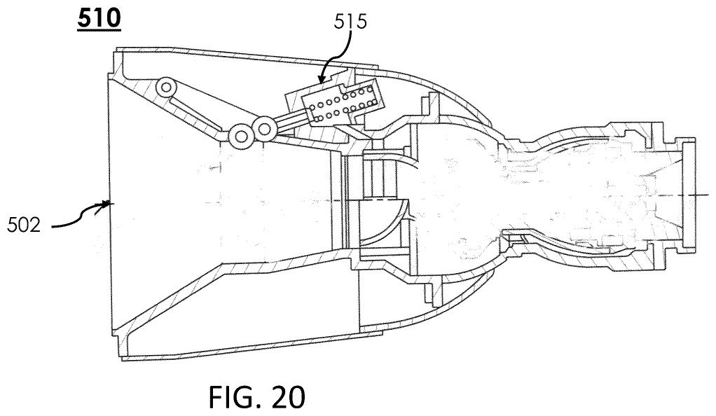

FIG. 20 depicts a cross-sectional view of a receiver charging receptacle 510, e.g., for an electric aircraft 12 that includes an opening 512 for receiving the chare/recharge probe and includes a latching mechanism 515 in the charge receptacle for closing around the probe of the boom once it is inside the receptacle so as to ensure tight connection at the charge socket 516 to latch the probe for providing charge current or receiving charge current.

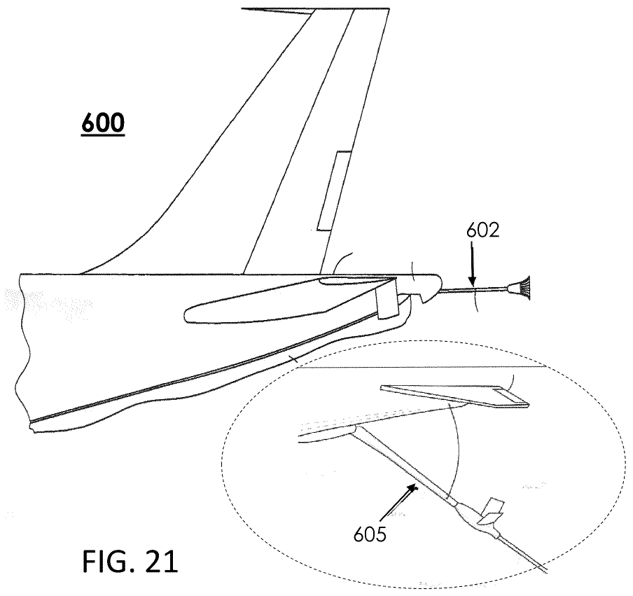

FIG. 21 depicts a further embodiment of an A2A electric aircraft recharging system 600 including a first sample “wing” boom deployment 602, e.g., with a probe for charging or receiving charge from another aircraft, and an alternative sample “rear” boom deployment 605, e.g., with a probe for charging or receiving charge from another aircraft. Recharging mid-air requires the transfer of electricity from one aircraft to another aircraft. The procedures require that the aircrafts fly in formation. The pilot unrolls a long hose from a wingtip or below the fuselage. There is a basket or a drogue at the end of the hose that looks like a windsock. Once the hose has reached the maximum extension, the pilot must insert the retractable probe into the receiver charge receptacle. The pilot must gently maneuver the probe so that it will latch into the receptacle. The latching process is added by the latching mechanism in the charge receptacle. This hand shaped device closes around the probe once it is inside the receptacle. Once this is done the hand shaped device is configured so that it pushes the probe closer to the charge socket located inside the receptacle. The hand shaped mechanism forces the probe to insert into the socket completely, thereby latching the two devices together. The pilot navigates the tube into the charge receptacle which is located near the front of the receiver plane. A signal is sent to the pilot once the latching has occurred to begin recharging. The ultracapacitor on both aircraft facilitates fast charging.

In particular, each aircraft in the configuration of FIGS. 19-21 is equipped to provide a first A2A mobile fast charging system for electric aircraft. In embodiments, an aircraft is equipped with any combination of the following recharging system components: one or more wing air recharging pods which are wing-mounted aerial recharging pods which feature a drogue recharging system which provide midair recharging capability for electric aircraft, a camera eye to monitor the recharging process, a centerline drogue recharging system which provide midair recharging capability for electric aircraft, an advanced fly by wire recharging boom which provide midair recharging capability for electric aircraft, and a recharging receptacle specially designed for electric aircraft. The charging boom has a variable drag drogue providing exceptional operating speed envelope capable of recharging all aircraft midair, dual redundant charge hose reel controls and sensors which accommodates a wide range of receiver aircraft, and an enhanced hose response shape optimized for feeding electric charging hoses and nozzles. This system can recharge other aircraft using the charging boom or accept charges from another aircraft using the charging receptacle. Both the charge receptacle and the charging boom are connected to the combiner smart ultracapacitor directly. Without the smart charge controller combiner, the recharging time would make this process untenable. The smart ultracapacitor can accept high voltage and current quickly and later trickle charge that current to the battery pack.

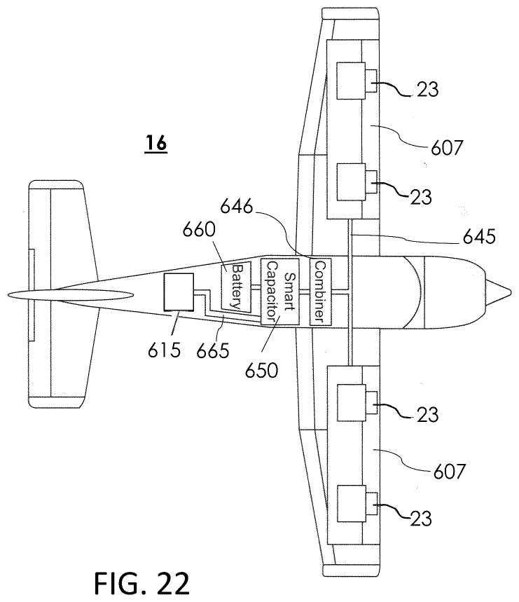

FIG. 22 depicts the Long-Range Electric Aircraft Configuration depicting several Paddlewheel Air Brake systems 23 at various locations on the wing edge 607 of the electric aircraft 16. Each paddlewheel air brake system 23 provides generated output electricity over an electrical conductor or power bus 645 to the combiner 646 which can forward the charge to a smart capacitor charge storage system 650 and/or the aircraft battery 660. The A2A controller receptacle 615 is shown connecting to the smart capacitor system 660 over a power bus 665 for either receiving charge from another plane or providing a stored charge to another plane via receptacle 615.

In FIG. 22, the hardware-processor or computer-based control system is configured to control each of the generation systems (PAB), (GAT), (GBR), etc., in a normal operational state wherein the charges from multiple inputs are combined into the smart charge combiner 646. This combiner device 646 further combines the multiple inputs from various generators and charge inputs into a single voltage and current for storage, or otherwise, controls the charges from multiple inputs and directs the flow of electricity to an appropriate system at the appropriate voltage. In embodiments, the hardware-processor or computer-based control system is configured to control the energy generation system(s) in a normal operational state, wherein the charges from multiple aircraft generator and charge inputs are combined and directed to the smart high capacity self-cooling ultracapacitor 650. The ultracapacitor 650 can also receive fast charging from other aircraft via the A2A recharging protocol. In addition, the ultracapacitor 650 can fast charge other aircraft. The smart ultracapacitor can trickle charge the battery system 660 to prevent degradation and overheating. This self-cooled system can also power the aircraft directly at the appropriate voltage and current requirements.

In an embodiment, the hardware-processor or computer-based control system is configured to control the system(s) in a normal operational state wherein a smart gear multiplier axle generator (PAB) as shown in FIGS. 4A-4D can automatically engage and disengage as needed, activate multiple gear combinations, and monitor data.

In an embodiment, the hardware-processor or computer-based control system is configured to control the energy generation system(s) in a normal operational state that ensures use of magnetic bearings to float certain components thereby greatly reducing friction.

In an embodiment, the hardware-processor or computer-based control system is configured to control the system in a normal operational state wherein the GAT-ECG device of FIGS. 12-13 includes a cylinder casing which has a spiral shaped conical device to direct the fluid flow down the center spiral and out of the base of the device, before exiting, which has winged openings that force the base of the device to spin. The base of the device has magnets attached to the sides, the top and bottom, that spin around the copper windings located in the outer casing of the device and parallel to the magnets. The spinning of the base creates a charge in the copper windings which is directed to the combiner. The fluid leaving the device pushes on the winged paddle angle openings and forces the base to rotate. This rotation turns the rotor base. The rotor base of this device has magnets on the side, top and bottom which are in close proximity to three copper coil stators which are parallel to the rotor magnets and affixed to the device. As the base spins, the magnets spin, they create electricity in the copper coils which power the generator such that the permanent magnets pass through the coil field of the copper wire where electricity is produced.

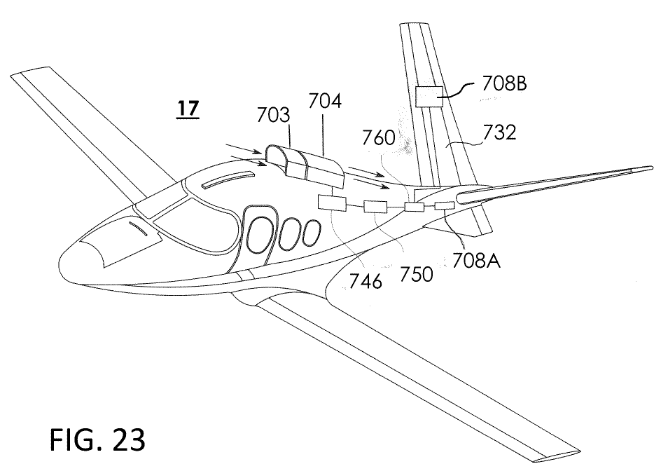

FIG. 23 depicts a Long-Range Electric Aircraft Configuration including an electric aircraft 17 incorporating a GAT 703, an exhaust turbine. The exhaust turbine is a rotary mechanical device that extracts energy from the exhaust fluid flow of the first generator and converts it into electricity 704, a smart charge computer combiner element 746, connected to feed generated electricity for storage at the ultracapacitor 750 and/or to the battery 760 used by the aircraft 17. FIG. 19 depicts alternated locations on the aircraft A2A for a first charge controller receptacle 708A connected to the battery at the rear of the plane, or alternatively placement of a charge controller receptacle, 708B, at or on a surface of the rear wing 732.

In an embodiment, the hardware-processor or computer-based control system is configured to control the system in a normal operational state wherein the charges from the charge receptacle can accept charges from another aircraft. The control system is further configured to control the system in a normal operational state wherein the charges stored in the ultracapacitor can be used to charge another aircraft using a charging boom or drogue system.

Each of the redundant electrical energy generation systems for the electric aircraft is super-efficient and computer controlled having a charge controller which is all completely concealed by the body of the aircraft. The magnetic field is created through electric current in a wire-wound coil. Each device passes the charge to the combiner which in turn passes the current to the smart ultracapacitor then to the battery bank Beneficial effect of the embodiments described herein include, but are not limited to: (1) increasing the range of an electric aircraft vehicle up to 1000%; (2) compared with traditional range extenders this device requires no additional fuels; (3), compared with traditional generators this device has much greater charging capacity and reliability; (4), compared with other types of recharging systems like regenerative breaking and diesel-powered range extenders, this system has lower coefficient of friction, generates an exponentially higher amounts of electricity and is infinitely more reliable; (5) systems are very applicable and can be installed on all existing electric aircraft; (6) compared to other range extenders this device lowers the sprung weight of the aircraft; and (7) compared to other range extenders this device has zero emissions.

The description of the invention has been presented for purposes of illustration and description, and is not intended to be exhaustive or to limit the invention in the form disclosed. Many modifications and variations will be apparent to those of ordinary skill in the art without departing from the scope of the invention. The embodiments were chosen and described in order to explain the principles and applications of the invention, and to enable others of ordinary skill in the art to understand the invention. The invention may be implemented in various embodiments with various modifications as are suited to a particular contemplated use.

What is claimed is:

1. A power generation system for an electric or hybrid aircraft vehicle, said power generation system comprising:
a high-speed, high efficiency, heat resistant, fluid turbine generator type range extender, motor and recharger apparatus having:
one or more computer controlled Concentrating Ducting Inlets (CDI) mounted to the outside surface of the electric aircraft for receiving air from outside the aircraft, said CDI having a diverging nozzle to accelerate received input air;
a hardware processor configured to control the flow of received air through each CDI; and one or more of:
a first electrical machine generator system connected to an output of said CDI for receiving the controlled air flow from an output thereof and for generating electricity responsive to the controlled air flow;
a second electrical machine generator system for connection to an output of the first electrical machine generator system, said second electrical machine generator for generating electricity responsive to the controlled air flow;
a third electrical machine generator system, said third electrical machine generator system comprising a dual blade rotor (BR) electrical generation system for generating electricity responsive to the motion of propeller blades; and
an energy storage and delivery system adapted to receive generated electricity from each of the first-, second- third-electrical machine generator systems and store said generated electricity for use by the aircraft.

2. The power system as claimed in claim 1, wherein said energy storage system comprises:
a charge combiner controllable by a processor device to receive multiple power inputs from one or more said first, second and third electrical machine generator systems and concentrate the received power input into a single voltage and current
a self-cooling ultracapacitor storage device controllable by the processor device to receive, store and deliver said single voltage and current; and
an aircraft battery or battery pack,
said processor device configured to control the energy storage system to one or more of:
a first operational state which directs generated electricity charge to the aircraft; or
a second operational state which directs generated electricity to a battery pack.

3. The power generation system as claimed in claim 1, further comprising:
an electrical system configured to provide electrical energy from the energy storage system to another aircraft, said processor device further configured to control the energy storage system to one or more of:
a third operational state for providing air-to-air recharging of another aircraft; or
a fourth operational state which allows for air-to-air recharging of the aircraft battery or battery pack.

4. The power generation system as claimed in claim 2, wherein said first electrical machine generator system comprises a Paddlewheel Air Brake (PAB) system for generating electricity, said PAB system comprising: a plurality of floating paddle wheel cylinders, each paddle wheel cylinder rotatable on a shaft and each paddle wheel cylinder having an outer casing that is floated using magnet bearings, said outer casing having a plurality of paddles affixed on a surface thereof for interacting with said received air flow from said CDI output for rotating said floating outer casing relative to an inner paddle wheel cylinder, wherein
said CDI having a CDI output for directing received air over the top of the floating paddlewheel cylinders in a wide thin high pressure stream during aircraft flight and taxiing, and
said processor device configured to control an opening of the CDI inlet to regulate said air flow at said CDI output during one or more of: electric aircraft vehicle braking, electric aircraft vehicle decelerating, or electric aircraft vehicle landing, said maximum receipt of said airflow resulting in increased rotation of said cylinder increasing a drag and friction to facilitate a deceleration and increases air flow pressure over the paddle wheels for maximum generation of electricity.

5. The power generation system as claimed in claim 4, wherein said paddle wheel outer casing is configured as a rotor to receive a maximum output of said air flow at said paddles for rotating the paddle wheel cylinder; and
the rotor comprising one or more of: copper windings or magnets being positioned on an inside wall of the paddlewheel cylinder for generating electricity, wherein
the paddle wheel cylinder comprises a central stator device, wherein the paddles affixed to the outside of the paddlewheel cylinder force the paddlewheel cylinder to spin around a center stator device, and wherein the processor device is configured to control the paddles of the paddlewheel cylinder to regulate an amount of air flow captured by said paddles during one or more of: electric aircraft vehicle braking, electric aircraft vehicle decelerating, or electric aircraft vehicle landing, and
wherein a maximum receipt of said airflow results in increased rotation of said cylinder, an increased a drag and friction to facilitate a deceleration, and an increased air flow pressure over the paddle wheels for maximum generation of electricity.

6. The power generation system as claimed in claim 5, wherein said paddle wheel outer casing is connected to a rotatable axle which is in a disengaged state during said aircraft flight and taxiing, allowing the floating outer casing rotor to spin frictionlessly at a high speed;
the airflow over the paddlewheel powers the first electrical generation system by turning the paddlewheel of the high-speed high efficiency paddlewheel generator which rotates the rotor around the central stator resulting in creation of a charge to be directed to the charge combiner.

7. The power generation system as claimed in claim 1, further comprising an Air Turbine (AT) with exhaust cone generator for generating electricity responsive to a controlled air flow output from the CDI, wherein an air pressure creates a rotational energy in several discs of said AT which spins an axle which powers the exhaust cone generator such that as the permanent magnets pass through the coil field of the copper wire where electricity is produced.

8. The power generation system as claimed in claim 6, wherein the second electrical machine generator system further comprises:
a high-capacity generator system comprising:
a smart gear multiplier, and
a smart axle, the smart axle configured to be engaged and activated during said aircraft braking, decelerating, or landing, for connection to the smart gear multiplier and an electric charge generator, said gear multiplier providing gearing forcing the axle to spin at a much higher speed thereby creating a higher volume of charge while simultaneously creating more drag and resistance which aids in the deceleration of the aircraft.

9. The power generation system as claimed in claim 7, wherein the Air Turbine (AT) with exhaust cone generator for generating electricity responsive to the controlled air flow comprises:
a first electrical energy generation subsystem powered by a single stream of air flow, the first generator having a housing adapted to receive a narrow stream of highly pressurized air flow from the CDI and directing the narrow stream of highly pressurized air flow into a casing chamber including a series of closely packed, parallel high-speed heat and warp resistant spiral etched circular disks which are attached to and rotatable with a shaft within the casing chamber, the pressurized air flow forcing a circular disc to spin rapidly during aircraft flight, which in turn spins a shaft, which in turn can spin a rotor to create electricity.

10. The power generation system as claimed in claim 9, wherein, upon detection of the aircraft in a landing or decelerating operation, the CDI inlet is opened to a maximum setting to regulate an air flow that aids in slowing the aircraft by increasing drag and to allow for the maximum airflow into the casing chamber to greatly increase an amount of electricity produced.

11. The power generation system as claimed in claim 10, wherein the housing comprise an inner casing and outer casing tangential to the inner casing, wherein CDI forced air output enters the outer casing, said outer casing holding the spiral etched circular discs in said chamber, and the inner casing holding a second generator comprising a spiral cone generator, wherein, responsive to the air entering the outer casing, an interaction between the air and the discs results in said discs spinning, said spinning discs connected to a shaft which spins the rotor in the generator to create electricity.

12. The power generation system as claimed in claim 11, wherein said outer casing providing an exit opening for the air to leave the outer casing at the center of the turbine, the air exiting a center of the turbine for redirection to a spiral cone generator within said inner casing, said turbine disc generator receiving said inlet fluid under pressure increasing a viscous centrifugal force on the discs, which in turn increases the RPM of the shaft resulting in producing more electricity.

13. The power generation system as claimed in claim 12, wherein the spiral etched discs are etched with a spiral pattern to promote a spiral movement, wherein when the air enters the chamber and passes between the disks, the disks turn, which in turn rotates the shaft, wherein a faster the turbine rotates the more energy it extracts from the air which creates greater RPMs at the shaft.

14. The power generation system as claimed in claim 13, further comprising:
a computer controlled electronic shim spacer (SESS) for electronically controlling a distance of a spacing between each spiral etched discs to increase their maximum efficiency and prevent overheating.

15. The power generation system as claimed in claim 13, wherein said spiral etched discs are arranged in a stepping staircase design to create a vortex within the casing that increases the rotational energy of the axle.

16. The power generation system as claimed in claim 15, further comprising: a pancake generator, the rotary motion of the spiral etched discs used to power the shaft used to rotate a pancake generator for generating electricity.

17. The power generation system as claimed in claim 13, wherein said spiral cone generator comprises a spiral cone shaped device, the cone shaped device having a base portion, the base portion having a series of paddle winged and angled openings, wherein a fluid pressure leaving an exhaust output from said AT turbine is forced down the spiral cone shaped device and exits the cone shaped device by interaction with the series of paddle winged and angled openings at the base of the device to force the base to rotate, said base adapted as a rotor used for generating said electricity, said rotor base having magnets on one or more of: a side, a top and a bottom which are in close proximity to one or more copper coil stators which are parallel to the rotor magnets and affixed to the device for providing a field to interact with the magnets to generate electricity, wherein the spinning of the base creates a charge in the copper windings which is directed to the charge controller combiner.

18. The power generation system as claimed in claim 1, wherein said electric aircraft comprises spinning propellor blades at or near a front of the aircraft used to power the forward motion of the aircraft, said spinning blades configured into one of: a rotor or stator, wherein said the spinning blades rotor spins the copper windings or magnets mounted on the blades proximate at least one circular stator positioned behind or in front of the spinning blade rotor, the spinning blade rotor rotating a magnet through a copper field to produce electricity which is diverted to the charge controller combiner for either powering the aircraft or recharging a battery bank.

19. The power generation system as claimed in claim 1, wherein said electric aircraft vehicle comprises two spinning blades for propulsion, wherein one blade comprises said spinning blade as the rotor and the other blade is adapted as a stator, where one said spinning blade adapted as the rotor is operated to spin in an opposite direction than the other spinning blade adapted as the stator to generate a maximum power by spinning the rotor in the opposite direction of the spinning stator.

20. The power generation system as claimed in claim 1, wherein said electric aircraft further comprises one or more of:
a charge receptacle and charge delivery boom;
a wing air recharging pods, wing-mounted aerial recharging pods having a drogue recharging system to facilitate midair recharging capability for the electric aircraft, and a camera eye to monitor controller for controlling a recharging process;
or alternatively comprising one or more of: a centerline drogue recharging system providing midair recharging capability for the electric aircraft, an advanced fly by wire recharging boom providing the midair recharging capability for electric aircraft, and
a recharging receptacle configured for electric aircraft, said recharging receptacle for recharging other aircraft using the recharging boom or accept charges from another aircraft, said recharging boom having a variable drag drogue providing operating speed envelope adapted for recharging all electric aircraft vehicles in midair, and
dual redundant charge hose reel control and sensor unit located to accommodate receiver electric aircraft, and an enhanced hose response shape optimized for feeding electric charging hoses and nozzles, wherein said charge receptacle and the recharging boom are connected to the combiner smart ultracapacitor.
